(19) United States
(12) Patent Application Publication
(10) Pub. No.: US 2005/0279799 A1
(43) Pub. Date: Dec. 22, 2005

(54) Medical equipment storage belt

(75) Inventors: Hiroaki Kubokawa, Sagamihara-shi (JP); Kazutaka Nakatsuchi, Tokyo (JP)

Correspondence Address: Thomas Spinelli;Scully, Scott, Murphy & Presser, 400 Garden City Plaza, Garden City, NY, 11530, US

(73) Assignee: OLYMPUS CORPORATION, TOKYO (JP)

(21) Appl. No.: 11/146,526

(22) Filed: Jun. 7, 2005

(30) Foreign Application Priority Data
Jun. 7, 2004 (JP) 2004-169069
Jun. 7, 2004 (JP) 2004-169070
Jun. 7, 2004 (JP) 2004-169071
Jun. 7, 2004 (JP) 2004-169072

(51) Int. Cl. B65G 43/08; B65G 49/02; A45C 1/04

(52) U.S. Cl. 224/665

(57) ABSTRACT

A medical equipment storage belt, which enables a subject to carry a medical equipment, includes a belt wound around a subject and storage sections which are provided in the belt section and store at least one medical equipment therein. Since the belt section which is used for carrying medical equipment is adopted, mounting and removing the medical equipment is easy. In the storage section of the medical equipment storage belt, an attachment portion may be provided, which is movably attached on the belt section. The storage section may be provided with openings for exposing a notification section so that the notification section can be visually checked. The belt-section may be provided with an electromagnetic weakening member. The belt section is further provided with a second storage section for power supply equipment and a power-supply-cord storage section.

### CROSS-REFERENCE TO RELATED APPLICATION

This application is based upon and claims the benefit of priority from prior Japanese Patent Application Nos. 2004-169069, 2004-169070, 2004-169071, 2004-169072, all of which were filed Jun. 7, 2004, the entire contents of each of which is incorporated herein by reference.

### BACKGROUND OF THE INVENTION

1. Field of the Invention

The present invention relates to a medical equipment storage belt in which medical equipment is stored.

2. Description of the Related Art

Recently, a capsule endoscope inspection is performed by a capsule-type endoscope capable of observing deep parts of a body cavity. In such a capsule endoscope inspection, the capsule-type endoscope, is swallowed by a subject to be introduced into the body cavity. The capsule-type endoscope is provided with an illuminating function and an imaging function in the main body thereof.

In the capsule endoscope inspection, an image signal which is taken by the imaging function provided in the capsule-type endoscope is radio-transmitted by a transmitting function provided in the capsule to a receiving device which is attached on the body of the subject. Accordingly, the image signal transmitted from the capsule-type endoscope is stored as image data in the receiving device. In addition, the image data stored in the receiving device is processed through a predetermined image processing, and the processed image data is displayed on a display device as an image observed by the endoscope.

For example, JP-A-2001-46357 discloses a radio capsule receiving system, which can safely detect the position of a radio capsule in a living body and collect living-body information. The radio capsule receiving system includes a radio capsule and an external unit. The radio capsule includes a sensor for detecting living-body information, a transmitter for transmitting the living-body information, a battery for supplying electric power, and transmission antennas. The external unit is a kind of a vest, which is worn by the subject and is provided with an antenna array having a plurality of antennas, a receiving module, a detachable memory, and power supply.

JP-A-2003-19111 discloses an array system and method, which detects the position of a signal source in a living body. The array system can detect the position of a signal source in a living body with an antenna array belt. The antenna array belt is wound around a patient so as to be attached on a signal recorder. The respective antenna elements of the array are connected to a connector, which is connected to the recorder, through a coaxial cable. In general, the antenna array belt has eight antenna elements positioned in the center area of a subject.

In the above described radio capsule receiving system and the array system and method for detecting the position of a signal source in a living body, the receiver for a capsule-type medical system is carried by a subject accommodated in a belt or vest. Accordingly, over a long time until the capsule swallowed through the mouth is expelled from the anus to the outside of the body for example, the signal related to the living-body information sent from the capsule-type medical equipment, is received with and is stored in the receiver.

However, in the technologies disclosed in JP-A-2001-46357 and JP-A-2003-19111, improvement of comfort for a subject, who has to carry the receiver containing a storage device and power supply for a long time, has not been considered at all.

JP-A-2001-46357 and JP-A-2003-19111 do not disclose a method in which a subject or a doctor checks an operation state of the receiver that receives and stores information over a long time.

Further, a countermeasure for weakening effects caused when the signal transmitted from the capsule-type medical equipment directly enters into the receiver has not been considered.

In addition, it has not been suggested to provide an accommodating section for detachably storing medical equipment such as receiver in a belt or a vest. Even though medical equipment is separated from power-supply equipment, handling of a power supply cord for connecting the medical equipment and the power-supply equipment has not been considered at all. For this reason, the power supply cord can become stuck on the body to give discomfort to a subject during the inspection or the power supply cord may be caught by the body or objects so that a load may be applied to the power supply cord.

The present invention has been made to decrease at least one of the above-mentioned problems in consideration of such circumstances.

### BRIEF SUMMARY OF THE INVENTION

A medical equipment storage belt of the present invention enables a subject to carry medical equipment and comprises a belt section to be wound around a subject and a storage section provided in or on the belt section for accommodating at least one medical equipment.

Since the belt section which is used for carrying medical equipment is adopted as described above, it is easy to carry medical equipment. In addition, since medical equipment is stored in the storage section, it is easy to remove the medical equipment from the belt.

As an improvement of the medical equipment storage, the storage section can be provided with an attachment portion, which is movably attached on the belt section.

By adopting such a configuration, the storage section, in which the medical equipment is stored, can be moved to the desired position with respect to the belt section to balance the medical equipment on the belt, which makes portability of the medical equipment greatly improved. In an inspection performed with a capsule-type medical system, the position of the storage section, in which the medical equipment is stored, may be adjusted with respect to the belt section in consideration of a weight balance of the medical equipment, and a body shape or preference of a subject. Accordingly, it is possible to provide the medical equipment storage, which a subject can comfortably carry for extended periods of time.

Further, belt fixing portions having coupling members may be provided on both ends of the belt so that the subject easily wears the medical equipment storage belt. In addition, a storage-section fixing portion having coupling members may be provided on the belt section and the attachment portion so that the movable storage section can be fixed after being moved into a desired position. The belt fixing portion may be utilized as the storage-section fixing portion.

The medical equipment storage belt may be used together with a suspension band In this case, attaching portions for attaching attachment tools of the suspension band are desirably provided to the belt section. When the attaching portion becomes a mark indicating the mounting place for the attachment tool of the suspension band to a subject, mounting operation becomes easy and is preferable. The attachment portion may be reinforced. In addition, if the storage-section fixing portion is provided closer to the center than the attachment portion, the storage section is effectively prevented from dropping.

As another improvement of the medical equipment storage belt, the storage section is provided with openings for exposing a notification section, which is provided on the medical equipment to notify an operation state, so that the notification section can be visually checked from outside the storage section.

According to such a configuration, the notification section provided on the medical equipment is visually checked through the openings of the storage section, even while the medical equipment is being carried by the subject. Therefore, it is possible to determine whether an operation state of the medical equipment is normal or abnormal. Since an operation state of the medical equipment can be checked in a state where the medical equipment is carried as described above, it is possible to provide the medical equipment storage belt decreasing problems caused by mechanical trouble of the medical equipment.

The notification section, for example, can be a display unit for visually displaying an operation state of the medical equipment. If the opening of the storage section is covered with a transparent member, the notification section of the medical equipment can be protected.

As still another improvement of the medical equipment storage belt, in the belt section, an electromagnetic wave weakening member, which weakens an unnecessary electric wave to be mixed into the receiver, is arranged in the vicinity of the storage section in which at least the medical equipment is stored.

Such a configuration is effective when the medical equipment includes a receiver for receiving a signal generated by a wireless capsule medical device as an electric wave.

According to such a configuration, since the electromagnetic wave weakening member is provided in the vicinity of the belt section provided with the storage section in which the medical equipment is stored, a wireless signal, which directly enters the medical equipment, is reduced significantly. As the storage section, in which the medical equipment is stored, is disposed in the vicinity of the belt section provided with the electromagnetic wave weakening member, an unnecessary electric wave mixed with a signal output from the wireless capsule medical device is weakened. Accordingly, it is possible to provide the storage belt for a receiver, which improves receiving and recording performance of the receiver and has excellent portability.

The electromagnetic wave weakening member can be, for example, a cloth provided inside an exterior of the belt section. In this example, the cloth may be formed by depositing a metal having an electromagnetic wave shielding property onto a surface of fabric formed of predetermined fibers, or by depositing a metal having an electromagnetic wave shielding property onto at least a portion of predetermined fibers used to weave the cloth.

As still another improvement of the medical equipment storage belt, the storage sections can comprise a first storage section that is provided on the belt section and in which a medical equipment is stored, and a second storage section, in which a power supply equipment for supplying electric power to drive the medical equipment is stored. In such a configuration, the medical equipment storage belt can further comprise a power-supply-cord storage section for storing excess length of a power supply cord which transmits electric power of the power supply equipment to the medical equipment.

With the power supply part of the medical equipment being separated, a balance of the belt is effectively improved. With the power-supply-cord storage section, wiring of power supply cord, which connects the medical equipment and the power supply equipment, does not interfere with the subject or other objects.

According to such a configuration, the excess of the power supply cord, which connects the medical equipment and the power supply equipment stored in the storage sections, is stored in the power-supply-cord storage section. Since the excess of the power supply cord, which connects the medical equipment and the power-supply equipment stored in the storage sections, is stored in the power-supply-cord storage section, discomfort is reduced, which is caused when the surplus length of the power supply cord is disposed in the vicinity of the belt section. Therefore, it is possible to provide the medical equipment storage belt having an excellent portability.

When both ends of the belt section are provided with coupling members constituting a belt fixing section for integrally fixing both of the ends of the belt section, the arranged position of the power-supply-cord storage section can be set on the belt section facing the coupling members which integrally fixes both of the ends in a state where the belt section is wound around a subject. Therefore, the power-supply-cord storage section is separated from both ends of the belt, so that the medical equipment and the power-supply section can be disposed in balance.

In addition, when the power-supply-cord storage section is disposed on a backside of a subject in a state where the belt section is wound around the subject, the power-supply-cord storage section does not get in the way.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a diagram illustrating a capsule-type endoscope system;

FIG. 2 is a diagram illustrating the receiving unit of FIG. 1;

FIGS. 3a, 3b, and 3c illustrate a front view, a top view, and a left-side view, respectively, of the receiver of FIG. 1;

FIG. 4 is a diagram illustrating the battery box of FIG. 1;

FIG. 5 is a perspective view illustrating the medical equipment storage belt of FIG. 1;

FIG. 6 is a perspective view illustrating a lateral surface of the medical equipment storage belt of FIG. 5;

FIG. 7 is a cross-sectional view illustrating a configuration of a backside forming section of the medical equipment storage belt of FIG. 6 as taken along line 7-7;

FIG. 8 is a cross-sectional view illustrating a configuration of a first-side forming section of the medical equipment storage belt of FIG. 6 as taken along line 8-8;

FIG. 9 is a cross-sectional view illustrating a configuration of a first storage section of the medical equipment storage belt of FIG. 6 as taken along line 9-9 where a lid portion of the first storage section is in a closed position;

FIG. 10 is a cross-sectional view illustrating a configuration of a second storage section of the medical equipment storage belt of FIG. 6 as taken along line 10-10;

FIG. 11 is a diagram illustrating the medical equipment storage belt of FIG. 6 including belt extending members, which are detachable to a side forming section.

### DETAILED DESCRIPTION OF THE PREFERRED EMBODIMENTS

Preferred embodiments of the invention are described below with reference to the accompanying drawings.

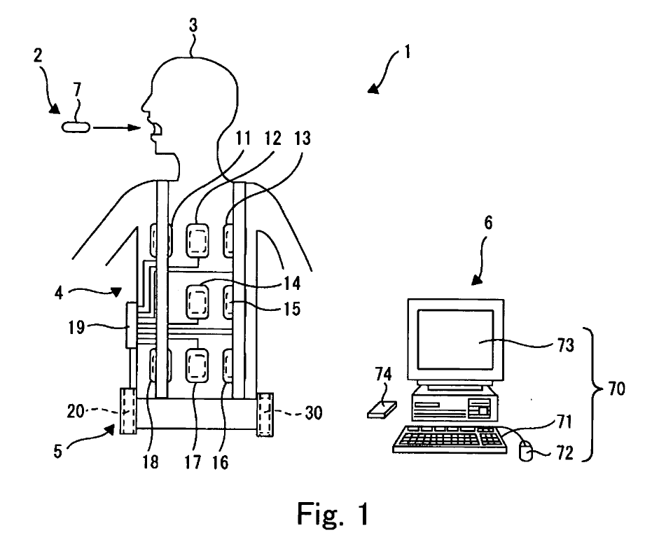

A capsule-type medical system of the present embodiment for performing a medical inspection is a capsule-type endoscope system 1 shown in FIG. 1. The capsule-type endoscope system 1 is mainly constituted by a capsule-type medical device (for example, a capsule-type endoscope 2) having a wireless function, a receiving unit 4 attached on a subject 3, a belt-like medical equipment storage belt (hereinafter, referred to as a storage belt) 5 for storing medical equipments constituting the receiving unit 4, and an external unit 6 provided away from the subject 3.

An observation device, an illuminating device, a signal processing device, a communication device, power supply, and the like, which are not shown, are provided in a capsule main body 7 of the capsule-type endoscope 2. The capsule-type endoscope 2 is swallowed by the subject 3 to be introduced into a body cavity. While the capsule-type endoscope 2 travels along a tract inside the body cavity, an inside image of the body cavity taken by the observation device is converted into a predetermined signal by the signal processing device and the converted signal is transmitted wirelessly to the receiving unit 4 through the communication device.

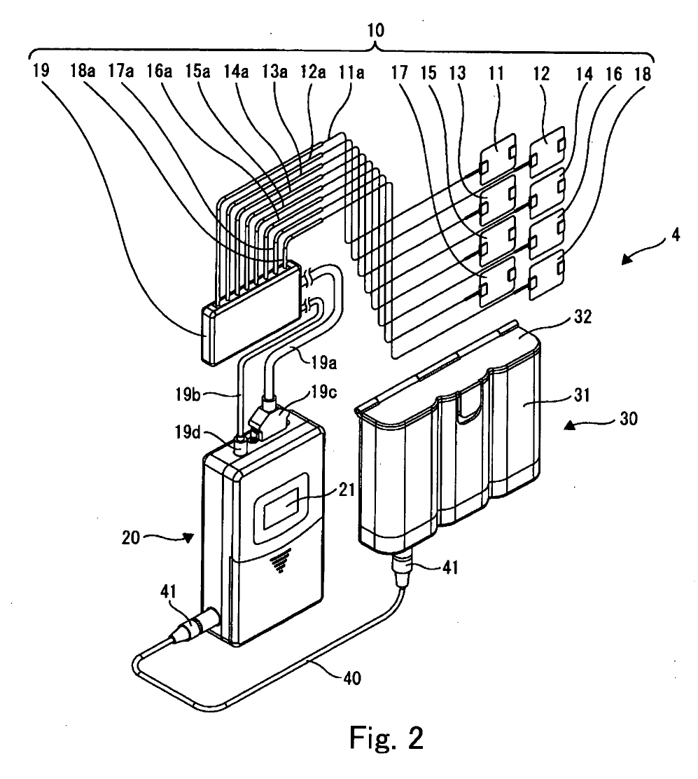

As shown in FIGS. 1 and 2, the receiving unit 4 is constituted by an antenna unit 10, a receiver 20 as a medical equipment, a battery box 30 as a power equipment for supplying power to the receiver 20, and a long power cord 40.

The antenna unit 10 is a receiving antenna for receiving a signal, which is transmitted from the communication device provided inside the capsule main body 7 of the capsule-type endoscope 2. The antenna unit 10 includes a plurality (for example, eight) of loop antennas 11-18 and an antenna switch (hereinafter, referred to as a switch) 19.

Each of the loop antennas 11-18 is disposed on the predetermined position, for example, of the abdomen of a subject. Antenna cables 11a-18a, which are constituted by coaxial lines having a good shielding property, are extended from the respective loop antennas 11-18. Each end of these antenna cables 11a-18a is connected to the switch 19. The loop antennas 11-18 disposed on the body surface of a subject are switched over by the switch 19 sequentially in a predetermined order (for example, a first loop antenna 11, a second loop antenna 12, . . . , a seventh antenna 17, and an eighth antenna 18). Then, the signal received by each of the loop antennas 11-18 is transmitted to the receiver 20.

Each length of the antenna cables 11a-18a is predetermined for each disposed position onto the body surface of the loop antennas 11-18. The first signal cable 19a transmits the signals received by the loop antennas 11-18 to the receiver 20 from the switch 19. At an end of the first signal cable 19a, a first connector 19c is provided. A second signal cable 19b transmits an indication signal sent from the receiver 20 to the switch 19. At the end of the second signal cable 19b, a second connector 19d is provided.

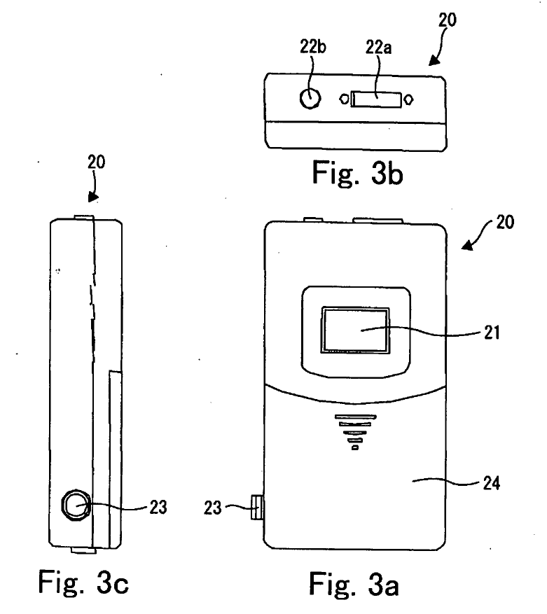

As shown in FIGS. 2 and 3a-3c, the receiver 20 has, for example, a box shape. The receiver 20 is provided with a liquid crystal monitor 21 as a display unit, antenna-unit connectors 22a and 22b, a power supply connector 23 which is detachably connected to a power supply cord 40, a recording-device storage section (not shown) in which a portable recording medium is stored. The display unit is not limited to the liquid crystal monitor 21, and may be, for example, an LED indicator group. In addition, an electrical circuit (not shown) such as a signal processing circuit for processing various signals is provided inside the receiver 20.

The first connector 19c is detachably connected to the antenna-unit connector 22a and the second connector 19d is detachably connected to the antenna-unit connector 22b.

The liquid crystal monitor 21 and the recording-device storage section are provided on the front side of the receiver 20. The antenna-unit connectors 22a and 22b are provided on the top of the receiver 20. The power supply connector 23 is provided on the left side toward the front side of the receiver 20. A slide cover 24 for covering the recording-device storage section slidably moves downward in FIG. 3 with respect to the receiver 20 so that the recording-device storage section is exposed. Components on the receiver 20 can be properly disposed according to its design.

The liquid crystal monitor 21 is a notification section for notifying an operational state visually. The liquid crystal monitor 21 displays, for example on the screen, an error message notifying that the signal cables 19a and 19b or the power supply cord 40 are not connected, an error message notifying that battery capacity of the battery box 30 is inadequate, a message notifying whether a signal is transmitted from the capsule-type endoscope 2 or not, and a receiving state.

The portable recording medium is a compact-flash-size hard disk drive having 1 GB (hereinafter, referred to as a HDD (see numeral 74 in FIG. 1)), which is detachably stored in the recording-device storage section.

The signal processing circuit selects the strongest signal among the signals, which are received by the respective loop antennas 11 to 18 to be transmitted through the switch 19. Then, the signal processing circuit processes the selected signal into inspection data for record retention (for example, image data in which a member of the loop antenna is recorded) to output to the HDD. As such, the image data obtained by the capsule-type endoscope 2 is sequentially stored as inspection data in the HDD.

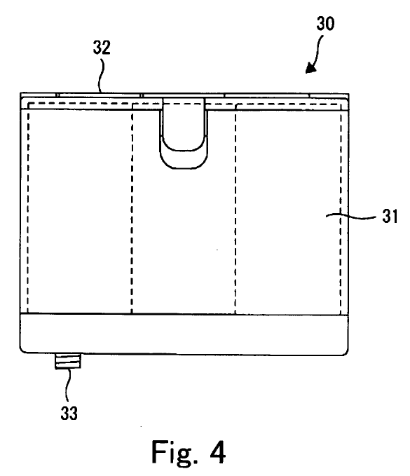

As shown in FIGS. 2 and 4, the battery box 30 having, for example, a box shape is provided with a box section 31 having a battery storage portion in which batteries (not shown) or the like is stored, a lid section 32 which is freely opened and closed to the box section 31, and a power supply connector 33 which is detachably connected to the power supply cord 40. With the lid section 32 being opened, the battery storage portion (not shown) is exposed so that batteries are exchanged.

As shown in FIG. 2, at both ends of the power supply cord 40, two connectors 41 are provided, which are detachable to the power supply connector 23 provided to the receiver 20 and the power supply connector 33 provided to the battery box 30, respectively. Since the receiver 20 and the battery box 30 are electrically connected with each other by the power supply cord 40, electric power of the battery stored in the battery storage section of the battery box 30 can be supplied to the receiver 20. As such, the battery box 30 as a power supply of the receiver 20 is provided separately from the receiver 20, so that the receiver 20 can be reduced in size and weight and the power supply can have a large capacity.

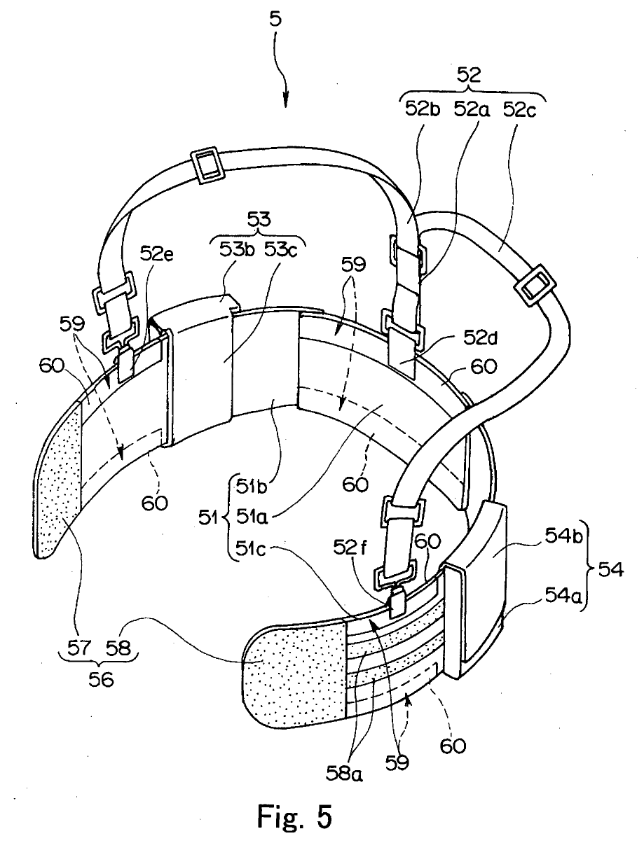

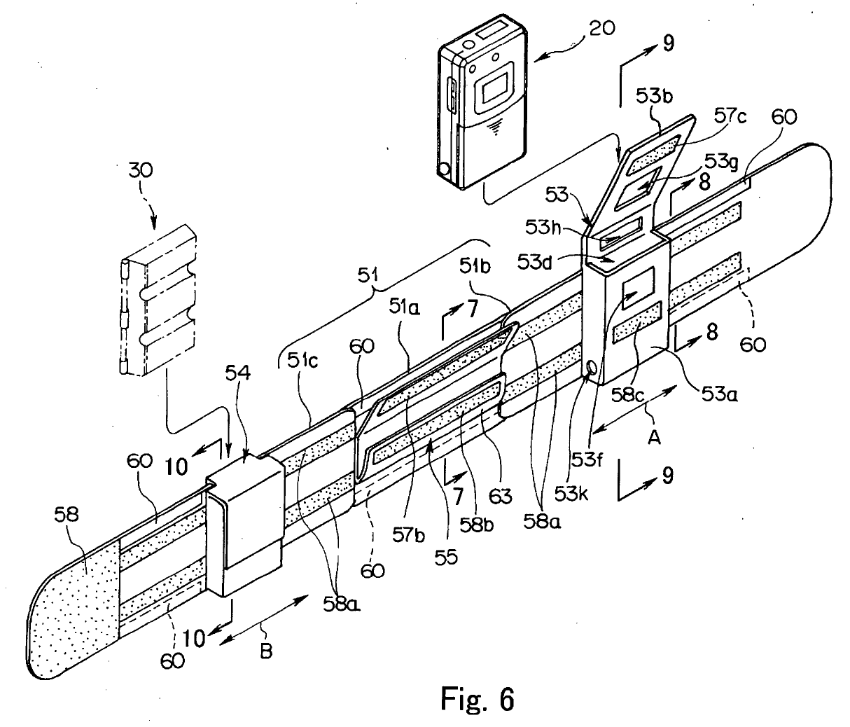

As shown in FIGS. 5 and 6, the storage belt 5 includes a belt section 51, a suspension band 52, a first storage section 53, a second storage section 54, and a power-supply-cord storage section 55. In this specification, hereinafter, one surface of the belt section 51, on which the body of a subject is brought into contact, is referred to an inner surface and the other surface on which the body of a subject is not brought into contact is referred to an outer surface.

The belt section 51 has a backside belt 51a, which corresponds to the back of a subject when worn by the subject and is so-called a back pad, and a pair of side belts 51b and 51c which are integrally provided to both ends of the backside belt 51a. In the first side belt 51b, for example, the first storage section 53, in which the receiver 20 is stored, is provided and, in the second side belt 51c, the second storage section 54, in which the battery box 30 is stored, is provided.

On an inner surface of an end portion of the first side belt 51b provided to the one end of the backside belt 51a, a planar hook-side member 57 is provided, which is one side of a surface fastener 56. On an outer surface of an end portion of the second side belt 51c, a planar loop-side member 58 is provided, which is the other side of the surface fastener 56. The surface fastener 56 having the hook-side member 57 and the loop-side member 58 is a coupling member for coupling both of the members and is a belt fixing section for fixing the belt around the subject.

In the longitudinal direction (e.g., along the length of the belt) of the outer surface of each of the side belts 51b and 51c, two strips of loop-side members 58a are provided parallel to each other. The loop-side member 58a is a storage-section fixing section for fixing a storage section. Moreover, the loop-side member 58a provided in the second side belt 51c also serves as a belt fixing section for fixing a belt.

As the hook-side member 57 provided in the first side belt 51b is pressed to be attached on the loop-side members 58 and 58a provided in the second side belt 51c, the hook-side member 57 is stuck on the loop-side members 58 and 58a. If so, the respective ends of the first side belt 51b and the second side belt 51c constituting the belt section 51 are integrally fixed. Accordingly, the belt section 51 can be wound around a subject and fixed in such wound configuration.

As the end of the first side belt 51b is pulled in the direction away from the end of the second side belt 51c, the above-described state is released where the hook-side member 57 is stuck on the loop-side members 58 and 58a. Accordingly, when the end of the first side belt 51b is again separated from the end of the second side belt 51c, the belt section 51 can be removed from the subject.

The suspension band 52 is constituted by a backside portion 52a and a pair of abdomen-side portions 52b and 52c. At the ends of the backside portion 52a and the pair of abdomen-side portions 52b and 52c, attachment tools 52d, 52e, and 52f are provided, respectively. The respective attachment tools 52d, 52e, and 52f are detachably attached on suspension band attaching portions 59 which are respectively provided on the longitudinal ends (the upper side in FIGS. 5 and 6) of the back-side belt 51a, the first side belt 51b, and the second side belt 51c constituting the belt section 51. When the suspension band 52 is attached to the belt section 51 so that the abdomen-side portions 52b and 52c of the suspension band 52 is put on the shoulder of a subject, the belt section 51 can be wound around the subject in a stable state.

The respective suspension band attaching portions 59 are provided with reinforcement cloth 60 which notifies the attached position to a user and enhances resistance to repeated attachment and removal of the attachment tools 52d, 52e, and 52f. One end of the reinforcement cloth 60 is disposed in the vicinity of the hook-side member 57 or the loop-side member 58 which is provided on the first side belt 51b or the second side belt 51c and the other end of the reinforcement cloth 60 is disposed in the vicinity of a substantial middle point of each of the side belts 51b and 51c.

Accordingly, the respective attachment tools 52e and 52f are disposed closer to the end side of the side belt than the respective storage sections 53 and 54. In other words, the respective storage sections 53 and 54 are disposed closer to the center than the respective attachment tools 52e and 52f.

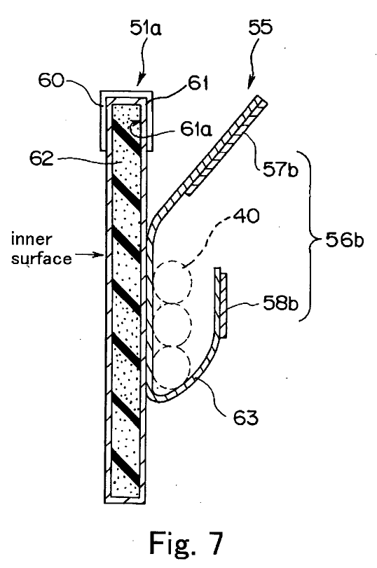

The backside belt 51a shown in FIG. 7 has an exterior cloth 61 for armoring the belt and a buffer member 62, which is a sponge-like urethane member. The exterior cloth 61 is formed in a bag shape and the buffer member 62 is provided inside a bag portion 61a of the exterior cloth 61.

In the backside belt 51a, a cord storage cloth 63 which is a power-supply-cord storage section 55 is provided on the outer surface of the exterior cloth 61 by any means known in the art, such as by stitching, adhesive or fasteners, such as hook and loop fasteners. On the inner side of one end of the cord storage cloth 63, a hook-side member 57b which is one side of a surface fastener 56b is provided and, on the outer side of the other end, a loop-side member 58b which is the other side of the surface fastener 56b is provided. In other words, the hook-side member 57b and the loop-side member 58b constitute a storage-cloth fixing section.

As described above, the backside belt 51a is provided with the cord storage cloth 63, which is provided with the hook-side member 57b and the loop-side member 58b. Accordingly, when the power supply cord 40, which electrically connects the receiver 20 to be stored in the first storage section 53 and the battery box 30 to be stored in the second storage section 54, has surplus cord, the surplus cord can be folded and stored in the cord storage cloth 63.

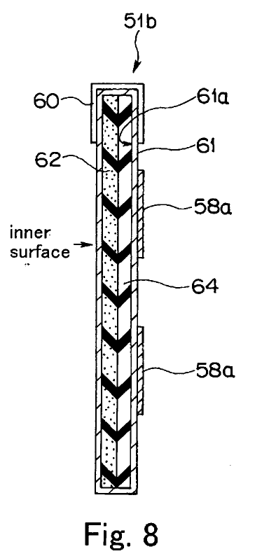

On the other hand, the first side belt 51b has the exterior cloth 61, the buffer member 62, and electromagnetic wave weakening material 64 which is an electromagnetic wave weakening member, as shown in FIG. 8. The electromagnetic wave weakening material 64 is arranged inside the bag portion 61a which is formed in the exterior cloth 61 together with the buffer member 62. The electromagnetic wave weakening material 64, which can weaken an unnecessary electric wave from being mixed, can be a fabric, such as a nonwoven fabric made of polyethylene terephthalate (hereinafter, referred to as a PET), a kind of cloth on which metal such as copper or nickel having an electromagnetic wave shielding property is evaporated, or a woven fabric cloth-woven out of PET string on which the described-above metal is evaporated.

The buffer member 62 is provided so as to be positioned toward the inner surface.

As the electromagnetic wave weakening material 64 is provided in the first side belt 51b on which the first storage section 53 in which the receiver 20 is stored is positioned, the signal transmitted from the capsule-type endoscope 2 traveling inside the body cavity is prevented from being directly received by the receiver 20. In other words, an unnecessary electric wave incident on the receiver 20 can be weakened or shielded.

The side belt 51c has the same structure as the backside belt 51a shown in FIG. 7, except that the side belt 51c does not have the cord storage cloth 63.

As the buffer member 62 is provided inside the backside belt 51a, the side belt 51b and the side belt 51c, a subject feels comfortable when the belt section 51 is worn around the subject.

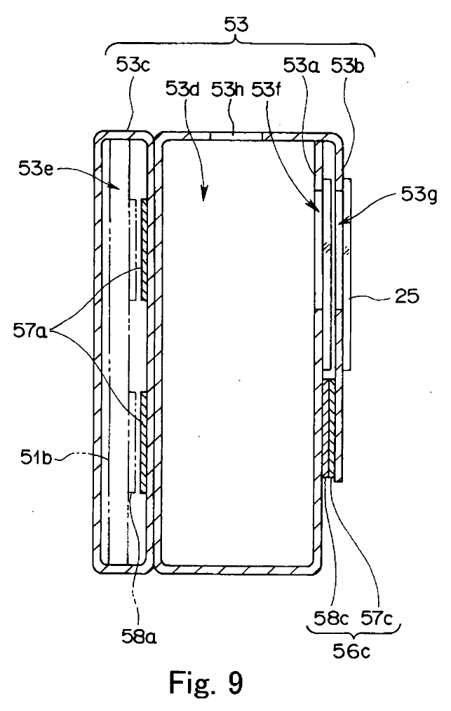

As shown in FIG. 9, the storage section 53 for storing the receiver 20 has a storage-section main body 53a, a lid portion 53b, and an attachment portion 53c. The storage-section main body 53a has a receiver storage space 53d and the attachment portion 53c has a belt disposition space 53e where the first side belt 51b is disposed to be loosely fitted for example.

In the predetermined position of the lid portion 53b, a hook-side member 57c constituting one side of a surface fastener 56c is provided. On the other hand, in the predetermined position of the storage-section main body 53a, a loop-side member 58c constituting the other side of the surface fastener 56c is provided. The surface fastener 56 is a lid fixing member. The lid portion 53b can be freely opened and closed to the storage-section main body 53a.

The belt disposition space 53e is formed in the attachment portion 53c. The hook-side member 57a is provided on the inner surface of the belt disposition space 53e toward the storage-section main body 53a. The hook-side member 57a is a fixing member for fixing the first storage section 53, together with the loop-side member 58a which is a fixing portion and is provided on the first side belt 51b. In the first side belt 51b, the first storage section 53 is disposed to be loosely fitted, so as to press the hook-side member 57a provided to the attachment portion 53c of the first storage section 53 to be attached on the loop-side member 58a of the first side belt 51b. Accordingly, the hook-side member 57a is stuck on the loop side member 58a and the first storage section 53 is disposed to be fixed to the first side belt 51b. In other words, the first storage section 53 is fixed to the belt section 51.

As the attachment portion 53c is pulled in the direction away from the first side belt 51b (in the longitudinal direction), the above-described fixed state is released where the hook-side member 57a of the attachment portion 53c disengages with the loop-side member 58a of the first side belt 51b. Accordingly, the first storage section 53 can move in the longitudinal direction of the first side belt 51b, as shown with an arrow A in FIG. 6.

As such, in the first storage section 53, the attachment portion 53c is provided, in which the hook-side member 57a corresponding to the loop-side member 58a provided on the first side belt 51b is provided. Accordingly, the disposed-to-be-fixed position of the first storage section 53 with respect to the longitudinal direction of the first side belt 51b can be freely adjusted.

On the other hand, in the predetermined position of the storage-section main body 53a and the lid portion 53b, a main-body opening 53f and a lid-portion opening 53g having a predetermined size are provided, through which the liquid crystal monitor 21 is exposed outside the storage section. Therefore, when the receiver 20 is arranged inside the receiver storage space 53d, information such as an error message, which is displayed on the liquid crystal monitor 21 provided to the receiver 20, can be visually checked through the lid-portion opening 53g and the main-body opening 53f. In at least one of the lid-portion opening 53g and the main-body opening 53f, a protection member 25 can be provided, which protects the liquid crystal monitor 21 of the receiver 20 and is formed of a transparent member.

In FIG. 6, reference numerals 53h and 53k represent openings. In a state where the receiver 20 is arranged in the receiver storage space 53d so that the lid portion 53b is integrally fixed to the storage-section main body 53a, the antenna-unit connectors 22a and 22b provided to the receiver 20 are positioned in the opening 53h and the power supply connector 23 provided to the receiver 20 is positioned in the opening 53k.

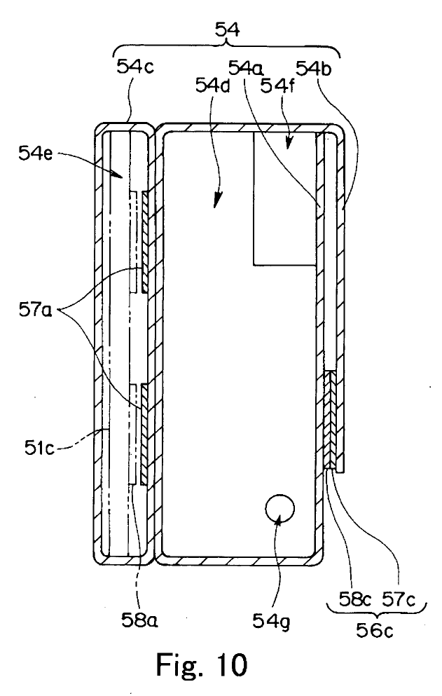

As shown in FIG. 10, the second storage section 54 for storing the battery box 30 is constituted by a storage-section main body 54a, a lid portion 54b, and an attachment portion 54c. The storage-section main body 54a has a battery-box storage space 54d and the attachment portion 54c has a belt disposition space 54e where the second side belt 51c is disposed to be loosely fitted.

In the predetermined position of the lid portion 54b, the hook-side member 57c constituting one side of the surface fastener 56c is provided. On the other hand, in the predetermined position of the storage-section main body 54a, a loop-side member 58c constituting the other side of the surface fastener 56c is provided. The surface fastener 56c is a lid fixing member. The lid portion 54b can be freely opened and closed to the storage-section main body 54a.

In the attachment portion 54c, the belt disposition space 54e is formed. The hook-side member 57a is provided in the inner side of the belt disposition space 54e toward the storage-section main body 54a. The hook-side member 57a is a fixing member for fixing the second storage section 54, together with the loop-side member 58a which is provided on the second side belt 51c and is a storage-section fixing portion. First, the hook-side member 57a, provided on the attachment portion 54c of the second storage section 54 which is disposed to be loosely fitted in the second side belt 51c, is pressed to be attached on the loop-side member 58a of the second side belt 51c. Accordingly, the hook-side member 57a is stuck on the loop-side member 58a, so that the second storage section 54 is disposed to be fixed to the second side belt 51c. In other words, the second storage section 54 is fixed to the belt section 51.

As the attachment portion 54c is pulled in the direction away from the second side belt 51c (in the longitudinal direction), the above-described fixed state is released where the hook-side member 57a of the attachment portion 54c disengages with the loop-side member 58a of the second side belt 51c. Accordingly, the second storage section 54 can move in the longitudinal direction of the second side belt 51c as shown with an arrow B in FIG. 6.

As such, in the second storage section 54, the attachment portion 54c is provided, and the hook-side member 57a corresponding to the loop-side member 58a provided on the second side belt 51c is provided in the attachment portion 54c. Accordingly, the disposed-to-be-fixed position of the second storage section 54 with respect to the longitudinal direction of the second side belt 51c can be freely adjusted.

Meanwhile, in the upper portion of the storage-section main body 54a toward the side lid portion, a notched portion 54f having a predetermined size is formed. The notched portion 54f assists in smoothly inserting the battery box 30 into the battery box storage space 54d. In addition, in the lower portion of the storage-section main body 54a toward the side lid portion for example, an opening 54g for exposing the power supply connector 33 outside is formed.

In the first side belt 51b and the second side belt 51c included in the belt section 51, the opening 54g opposes the opening 53k in a state where the first storage section 53 and the second storage section 54 are attached on the first side belt 51b and the second side belt 51c, respectively.

The present embodiment has a configuration where the electromagnetic wave weakening material 64 is provided inside the bag portion 61a of the exterior cloth 61 constituting the first side belt 51b. However, without being limited to the above configuration, the present embodiment may have a configuration, for example, where the electromagnetic wave weakening material 64 is similarly provided inside the bag portion 61a of the exterior cloth 61 constituting the back-side belt 51a and the second side belt 51c or where the electromagnetic wave weakening material 64 is provided in the storage portion 53a and the lid portion 53b constituting the first storage section 53 in which the receiver 20 is stored. In this case, the storage portion 53a and the lid portion 53b are formed in a bag shape. Accordingly, an unnecessary electric wave can be more effectively prevented from being mixed into the receiver 20.

The suspension belt attaching portions 59 provided with the reinforcement cloth 60 may be provided to both of the longitudinal-direction ends, as shown with dashed lines in FIGS. 5 and 6. In this case, the electromagnetic wave weakening material 64 is provided inside the bag portion 61a of the exterior cloth 61 constituting the first side belt 51b and the second side belt 51c or the electromagnetic wave weakening material 64 is provided to the storage portion 53a and the lid portion 53b constituting the first storage section 53 in which the receiver 20 is stored. Accordingly, the first side belt 51b constituting belt section 51 is selectively disposed in front of the left side or the right side so that the belt section 51 can be wound.

As shown in FIG. 1, the external unit 6 can be a personal computer 70 (hereinafter, referred to as a PC). The PC 70 is provided with a keyboard 71 serving as a manipulating board for manipulating data input, a mouse 72, and a display unit 73 such as a liquid crystal panel, which is a display device. The HDD 74, which is detachably stored in the recording-device storage section of the receiver 20, is connected directly or through a communication cable such as a USB cable for communication to the PC 70.

With the HDD 74 and the PC 70 being connected with each other, the inspection data stored in the HDD 74 is transmitted to a recording medium (not shown) which is provided inside the PC 70 and the inspection data is also processed so that an endoscope image or the like can be displayed on the display unit 73.

The present embodiment has a configuration where the switch 19 is separated from the receiver 20. However, the switch 19 may be incorporated into the receiver 20.

In the present embodiment, the belt section 51 is constituted by the backside belt 51a, the first side belt 51b, and the second side belt 51c. However, the belt section 51 may be constituted by one belt-like member. In this case, in order that the belt-like member has a configuration nearly corresponding to the configuration of the above-described belt section 51, the belt-like member can be provided with the hook-side member 57, the loop-side member 58, the loop-side member 58a, the power-supply-cord storage section 55, the suspension band attaching portion 59, the buffer member 62, the electromagnetic wave weakening material 64 and the like.

An operation of the capsule-type endoscope system 1 having the above-described configuration will be described.

First, a handler (for example, a doctor or a nurse) prepares the receiving unit 4 and the storage belt 5. Then, the respective loop antennas 11 to 18 are covered by a bag-like member made by paper. Then, the handler sticks a sticking surface provided on one side of the bag-like member on a predetermined sticking position on the abdominal surface of a subject.

The handler adjusts the belt section 51 wound around the subject and the suspension band 52 attached to the belt section 51, in accordance with the subject.

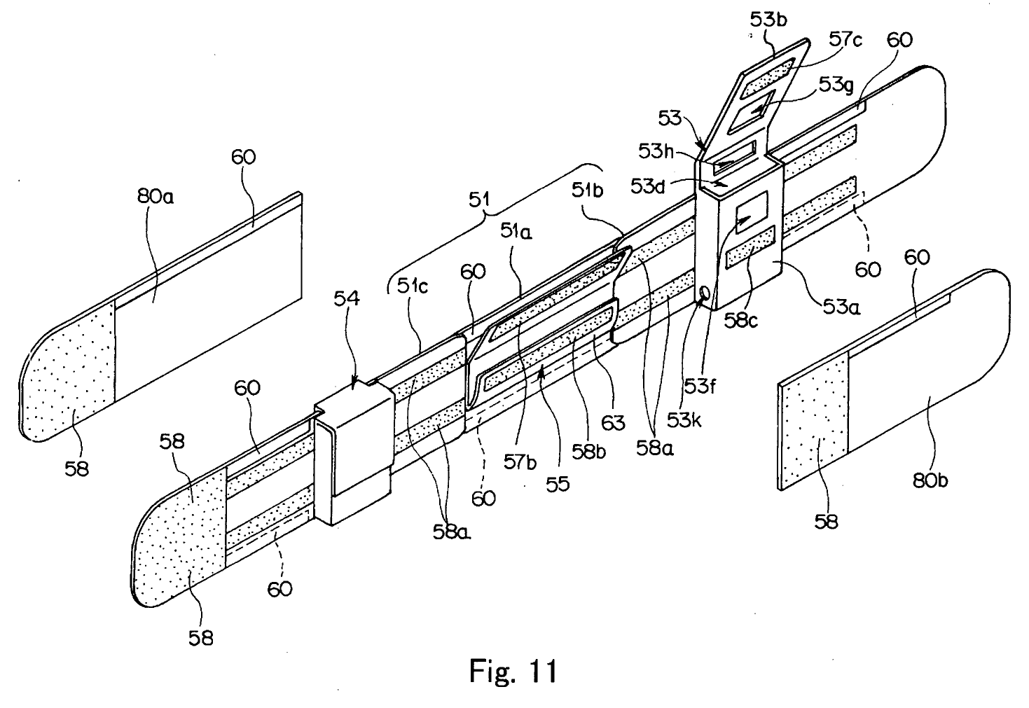

At this time when the belt section 51 is short, at least one of belt extending members 80a and 80b are disposed to be fixed to at least one of the side belts 51b and 51c, as shown in FIG. 11. The respective belt extending members 80a and 80b are provided with the hook-side member 57 (not shown) and the suspension band attaching portion 59 which is constituted by the loop-side member 58 and the reinforcement cloth 60. Accordingly, the length of the belt section 51 can be adjusted in accordance with a subject.

Next, the handler adjusts the longitudinal position of the first storage section 53 provided on the first side belt 51b constituting the belt section 51 and the longitudinal position of the second storage section 54 provided on the second side belt 51c. Then, the attachment tool 52d provided to the suspension band 52 is attached to the suspension band attaching portion 59 of the backside belt 51a. In addition, the attachment tool 52e is attached to the suspension band attaching portion 59 which is positioned closer to the front end than the first storage section 53 and the attachment tool 52f is attached to the suspension band attaching portion 59 which is positioned closer to the front end than the second storage section 54.

Accordingly, the respective storage sections 53 and 54 can be disposed closer to the center than the respective attachment tools 52e and 52f. Therefore, even if the hook-side member 57 provided on the first side belt 51b constituting the belt section 51 is separated from the loop-side member 58 provided on the second side belt 51c, the storage sections 53 and 54 can be prevented from easily dropping from the belt section 51.

Next, the handler stores the receiver 20, of which main power is turned on, in the receiver storage space 53d of the first storage section 53 so that the lid portion 53b is integrally fixed to the storage portion 53a, as shown in FIG. 6. Further, the handler stores the battery box 30 in the battery box storage space 54d of the second storage section 54 so that the lid portion 54b is integrally fixed to the storage portion 54a.

Then, the handler electrically connects the connectors 41, which are provided on the power supply cord 40, to the power supply connector 23 of the receiver 20, which is exposed from the opening 53k of the first storage section 53, and to the power supply connector 33 of the battery box 30 which is exposed from the opening 54g of the second storage section 54, respectively. At this time when the power supply cord 40 has surplus cord, the surplus cord is disposed so as to be stored in the cord storage cloth 63.

At this moment, the hook-side member 57b provided on the cord storage cloth 63 is pressed to be attached on the loop-side member 58b. If so, the surplus cord of the power supply cord 40 is stored in the cord storage cloth 63. Accordingly, the surplus cord of the power supply cord 40 can be reliably prevented from drooping from the belt section 51 wound around the subject.

After that, the handler disposes the abdomen-side portions 52b and 52c of the suspension band 52 on the shoulder of the subject so that the belt section 51 is wound around the waist of the subject in a desired state. At this time, the hook-side member 57 provided on the first side belt 51b or the belt extending member 80b is pressed to be attached on the loop-side members 58 and 58a provided on the second side belt 51c or the loop-side member 58 provided on the belt extending member 80a. Accordingly, the belt portion 51 is fixed around the waist of the subject.

Next, if necessary, the handler can readjust the disposed position of the storage section 53 in which the receiver 20 is stored and the storage section 54 in which the battery box 30 is stored. As a result, the storage sections 53 and 54, which are provided on the belt section 51 wound around the subject, are disposed in a desired optimal state.

Next, the handler connects the first connector 19c provided to the first signal cable 19a and the second connector 19d provided to the second signal cable 19b, respectively, to the antenna-unit connector 22a and the antenna-unit connector 22b which are exposed from the opening 53h of the first storage section 53. Accordingly, as shown in FIG. 1, a combination of the receiving unit 4 and the storage belt 5 are worn by the subject 3, so that the receiver 20 and the battery box 30 can become portable.

At this moment, in order to switch over to inspection, the handler prepares the capsule-type endoscope 2. Before introducing the capsule-type endoscope 2, the handler visually checks the contents displayed on the liquid crystal monitor 21 provided on the receiver 20, through the lid-portion opening 53g and the main-body opening 53f. When abnormalities are not present, the capsule-type endoscope 2 is introduced into the body cavity through the mouth.

If the capsule-type endoscope 2 is introduced into the body cavity of the subject, a signal including a body cavity image or the like taken by the observation device of the capsule-type endoscope 2 is transmitted wirelessly through the communication device. Then, the signal is received by the respective loop antennas 11 to 18 adhered to the body surface to be transmitted to the receiver 20. At this time, since the first side belt 51b provided with the first storage section 53 in which the receiver 20 is stored is provided with at least the electromagnetic wave weakening material 64, the signal transmitted from the capsule-type endoscope 2 is not mixed into the receiver 20, but is transmitted to the receiver 20 through the loop antennas 11 to 18 and the switch 19. In the receiver 20, a predetermined signal processing is performed into the image data obtained by the capsule-type endoscope 2 so that the produced inspection data is sequentially stored in the HDD 74.

After a predetermined time has passed, the contents which is displayed on the liquid crystal monitor 21 provided on the receiver 20 is checked through the lid-portion opening 53g and the main-body opening 53f. When the doctor or the like determines that the inspection proceeds smoothly, the subject is released from observation of the doctor, so that it becomes in an inspection continuing state. In the inspection continuing state, the subject is allowed to freely move in a predetermined range until the inspection is completed (e.g., until the capsule-type endoscope traverses the digestive tract and passes from the body).

Under the inspection continuing state where the subject is released from observation of the doctor, the subject visually checks the contents, which is displayed on the liquid crystal monitor 21 through the lid portion opening 53g and the main-body opening 53f, to confirm whether abnormalities occur or the subject properly adjusts the position of the storage sections 53 and 54.

Accordingly, in the state where the subject is released from the doctor, the subject can check the operation state of the receiver 20 and comfortably spend extended periods of time while undergoing the internal inspection.

When the inspection is completed, the handler removes the first signal cable 19a, the second signal cable 19b and the power supply cord 40 from the receiver 20 and the battery box 30 which are respectively stored in the storage sections 53 and 54 provided on the belt section 51. After that, the handler removes the storage belt 5 from the subject as well as the loop antennas 11 to 18 and the switch 19. Then, the subject is released from inspection.

After that, the handler removes the HDD 74 from the receiver 20 to connect the HDD 74 to the PC 70. Then, the handler transmits the inspection data stored in the HDD 74 to the recording medium provided inside the PC 70 or displays the endoscope image on the display unit 73.

In the present embodiment, the attachment portion, which is provided with the hook-side member in the storage section in which the medical equipment is stored, is disposed to be fitted in the side belt provided with the loop-side member. Accordingly, the disposed position of the storage section in which the medical equipment is stored can be properly adjusted with respect to the respective side belts so that the storage section is disposed to be fixed.

As a result, the medical equipment, which is stored in the storage section provided on the belt section, can be put on the body of a subject in a state where the weight is balanced or the storage section can be disposed to be fixed to the preferable position for a subject so that the subject can comfortably carry the medical equipment for a long time.

As the hook-side member and the loop-side member are provided on the respective front ends of the side belts constituting the belt section, the belt section can be easily fixed and removed.

Further, the suspension band is positioned more outward than the storage section provided on the belt section. Therefore, even if the fixed state is released where the hook-side member provided on the end of the belt section is stuck on the loop-side member, the storage section provided on the belt section can be prevented from dropping from the belt section.

In the present embodiment, in the storage-section main body and the lid portion constituting the storage section in which the receiver, or the medical equipment is stored, the main-body opening and lid-portion opening having a predetermined size are provided, which expose the liquid crystal monitor provided on the receiver arranged in the receiver storage space of the storage section to the outside of the storage section. Accordingly, information such as an error message or the like displayed on the liquid crystal monitor can be checked with eyes by a subject who carries the receiver with him or her.

Since the protection member formed of a transparent member is provided on at least one of the lid-portion opening or the main-body opening, the liquid crystal monitor provided on the receiver can be protected from the outside environment, without deteriorating a visibility of information such as an error message.

In the present embodiment, the electromagnetic wave weakening material is provided inside the bag portion of the exterior cloth constituting at least the first side belt provided with the storage section in which the receiver is stored. Accordingly, the signal, which is transmitted from the capsule-type endoscope traveling inside the body cavity, can be directly received by the receiver. In other words, an unnecessary electric wave mixed into the receiver can be weakened significantly.

In addition, as the electromagnetic wave weakening material is provided in the storage-section main body and the lid portion constituting the first storage section in which the receiver is stored, an unnecessary electric wave mixed into the receiver can be weakened and further, a signal can be effectively prevented from being distorted by noise.

In the present embodiment, on the backside belt disposed on the back of a subject, the cord storage cloth is provided, which is provided with the hook-side member and the loop-side member. Such a configuration makes it possible that surplus of the power supply cord, which electrically connects the receiver stored in the first storage section and the battery box stored in the second storage section, is folded and stored in the cord storage cloth so that any surplus length of the power supply cord can reliably be prevented from drooping from the belt section wound around a subject.

As a result, unpleasantness that a subject wearing the belt sections feels is reduced, which is caused by the power supply cord stuck on the body on inspection. In addition, unintentional power-supply disconnection is prevented, which is caused when the power supply cord is caught by part of the body, structures or the like.

When the first storage section and the second storage section are respectively arranged on the first side belt and the second side belt constituting the belt section, the opening provided on the first storage section is disposed to oppose the opening provided on the second storage section, so that it can be confirmed that the first storage section and the second storage section are arranged in a predetermined state.

The procedure where the receiving unit 4 and the storage belt 5 are incorporated is not limited to the above-described procedure. For example, after the belt section 51 is wound around the waist, the receiver 20 and the battery box 30 may be stored in the storage sections 53 and 54.

The fixing member is not limited to the surface fastener. For example, pegs, buttons, snaps or the like may be used.

Although wireless capsule medical equipment has been explained as the capsule-type endoscope 2 in the present embodiment, the wireless capsule medical equipment is not limited to the capsule-type endoscope 2. For example, a capsule-type ultrasonic endoscope may be provided, in which an ultrasonic probe is arranged inside the capsule main body 7. On the outer surface of the capsule main body 7, various sensors may be provided to be exposed, so that they are fixed to the capsule main body to keep watertightness to the inside of the capsule. They are an optical sensor for detecting brightness inside a living body (specifically, a tract line inside the body cavity of a man or an animal), a pH sensor for detecting a stoichiometric value (pH value) of internal fluid, a temperature sensor for measuring a temperature, a pressure sensor for detecting pressure, a blood sensor (hemoglobin sensor) for measuring an amount of hemoglobin (presence or absence of bleeding). Even in this capsule, the information obtained by the respective sensors is transmitted to the outside of the body by the communication device to be stored as inspection data through the loop antennas 11 to 18 into the HDD 22 which is built in the receiver 20.

According to the capsule provided with a sensor as described above, abnormalities such as a disease, bleeding, and the like can be detected by comparing the data obtained by the sensor to a reference value, for example. Further, the passing position for the capsule can be detected outside the body by a medical service worker. In particular, since a pH value and an amount of hemoglobin inside the alimentary tract of a living body are measured without any pain caused by the capsule-type medical equipment, a diagnosis of digestive disease and physiological analysis can be performed very effectively. In addition, various sensors are provided on the outer surface of the capsule main body 7 according to a certain purpose, so that inspection can be performed effectively.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

1. A medical equipment storage belt, which enables a subject to carry medical equipment, the medical equipment storage belt comprising:
a belt section to be wound around the subject; and
storage sections provided on the belt section for storing at least a medical equipment therein.

2. The medical equipment storage belt according to claim 1,
wherein the storage section has an attachment portion movably attached to the belt section.

3. The medical equipment storage belt according to claim 2,
wherein belt fixing portions having coupling members are provided on both ends of the belt section.

4. The medical equipment storage belt according to claim 2,
wherein storage-section fixing portions having coupling members are provided in the belt section and the attachment portion.

5. The medical equipment storage belt according to claim 4,
wherein the storage-section fixing portion also has a usage as a belt fixing member.

6. The medical equipment storage belt according to claim 3, further comprising
a suspension band to be suspended on the shoulder of the subject to support the belt section and includes attachment tools capable of detaching from and attaching on the belt section,
wherein attachment portions for attaching the attachment tools provided to the suspension band are provided in the belt section.

7. The medical equipment storage belt according to claim 6, wherein the attachment tools comprise three attachment tools corresponding to three attachment portions, wherein one of the three attachment portions being provided in a vicinity of a center of the belt section and others of the three attachment portions being respectively provided in an area closer to the center than the belt fixing members.

8. The medical equipment storage belt according to claim 7,
wherein the storage-section fixing portion is provided closer to the center than the attachment portions provided in the area closer to the center than the belt fixing members.

9. The medical equipment storage belt according to claim 1,
wherein at least one of the storage sections has an opening for exposing a notification section provided in the medical equipment stored therein to notify an operation state, so that the notification section can be visually checked from outside the at least one storage section.

10. The medical equipment storage belt according to claim 9,
wherein the notification section is a display unit for visually displaying an operation state of the medical equipment.

11. The medical equipment storage belt according to claim 9,
wherein the opening is provided with a transparent member.

12. The medical equipment storage belt according to claim 1,
wherein the medical equipment includes a receiver for receiving a signal generated by a wireless capsule medical equipment as an electric wave,
wherein, in the belt section, an electromagnetic wave weakening member for weakening the electric wave and preventing the electric wave from being mixed into the receiver is arranged in the vicinity of the storage section in which at least the medical equipment is stored.

13. The medical equipment storage belt according to claim 12,
wherein the electromagnetic wave weakening member is a cloth provided inside an exterior of the belt section.

14. The medical equipment storage belt according to claim 13,
wherein the cloth is formed by at least one of depositing a metal having an electromagnetic wave shielding property onto the surface of a fabric formed of predetermined fibers and by depositing a metal having an electromagnetic wave shielding property onto at least a portion of predetermined fibers used to weave the cloth.

15. The medical equipment storage belt according to claim 1, wherein the storage sections comprise:
a first storage section provided on the belt section and in which a medical equipment is stored;
a second storage section provided on the belt section and in which a power supply equipment for supplying electric power to drive the medical equipment is stored.

16. The medical equipment storage belt according to claim 15, further comprising a power-supply-cord storage section for storing excess of a power supply cord for transmitting electric power of the power supply equipment to the medical equipment.

17. The medical equipment storage belt according to claim 16,
wherein the belt section further has coupling members constituting a belt fixing section for integrally fixing both ends of the belt section, and the power-supply-cord storage section is provided on a part of the belt section facing the coupling members for coupling both ends integrally in a state where the belt section is wound around the subject.

18. The medical equipment storage belt according to claim 17,
wherein the power-supply-cord storage section is disposed at a backside of the subject in a state where the belt section is wound around the subject.
